(19) United States
(12) Patent Application Publication
(10) Pub. No.: US 2018/0285555 A1
(43) Pub. Date: Oct. 4, 2018

(54) AUTHENTICATION METHOD, DEVICE AND SYSTEM

(71) Applicant: Alibaba Group Holding Limited, George Town (KY)

(72) Inventors: Kan Dong, Hangzhou (CN); Dunjun Liu, Hangzhou (CN)

(21) Appl. No.: 15/951,611

(22) Filed: Apr. 12, 2018

Related U.S. Application Data
(63) Continuation-in-part of application No. PCT/CN2016/101642, filed on Oct. 10, 2016.

(30) Foreign Application Priority Data
Oct. 14, 2015 (CN) 201510662102.4

(51) Int. Cl. G06F 21/44; H04W 12/06; H04W 12/04; H04L 9/32; H04L 9/08; H04L 29/06

(52) U.S. Cl. CPC G06F 21/44; H04W 12/06; H04W 12/04; H04L 9/3213; H04L 9/3228; H04W 88/02; H04L 9/0869; H04L 9/0894; H04L 63/10; H04L 63/0428; H04L 9/0825

(57) ABSTRACT

The present invention provides methods, devices, and systems for device identity authentication. A method for identity authentication comprises: obtaining, by one or more processors associated with an authenticatee terminal, a device encryption key, obtaining, by one or more processors associated with the authenticatee terminal, second data based at least in part on the device encryption key and first data, wherein obtaining the second data comprises at least one of signing or encrypting the first data, and the first data comprises a random number, generating, by one or more processors associated with the authenticatee terminal, an authentication code based at least in part on the second data and an identifier (ID) of the authenticatee terminal, and communicating, by one or more processors associated with the authenticatee terminal, the authentication code to an authenticator equipment.

### CROSS REFERENCE TO OTHER APPLICATIONS

This application is a continuation-in-part of and claims priority to International (PCT) Application No. PCT/CN16/101642 entitled EQUIPMENT IDENTITY AUTHENTICATION METHOD, DEVICE AND SYSTEM, filed Oct. 10, 2016 which is incorporated herein by reference for all purposes, which claims priority to China Application No. 201510662102.4 entitled A METHOD, MEANS, AND SYSTEM FOR DEVICE IDENTITY AUTHENTICATION, filed Oct. 14, 2015 which is incorporated herein by reference for all purposes.

### FIELD OF THE INVENTION

The present application relates to a field of computer application technology. In particular, the present application relates to a method, device, and system for authentication of a device identity.

### BACKGROUND OF THE INVENTION

Hardware devices are each associated with a corresponding International Mobile Equipment Identity (IMEI). For example, IMEIs are permanently inscribed in hardware devices at the time of shipment from factories of the manufacturer of such hardware devices. An IMEI corresponding to a hardware device cannot be altered or erased. However, because any person can obtain an IMEI (e.g., IMEIs are expressly available to outside parties by the nature of the IMEIs being marked on a hardware device), an IMEI can generally only be used as an identifier in connection with the sales process (e.g., the sale of the corresponding hardware device). Applications running on a device can easily acquire IMEIs. Accordingly, after a device enters a network, malicious third parties can easily forge or falsify an IMEI during network identity authentication. Because of the ease with which malicious third parties can forge or falsify an IMEI, the use of an IMEI for purposes of device identity authentication is potentially inaccurate and insecure.

The problem with the related art method of using IMEIs associated with hardware devices for purposes of device authentication is that such an authentication method is insecure and exposes networks to vulnerabilities. Accordingly, a method for authenticating a device that is not vulnerable to malicious third parties is needed.

### BRIEF DESCRIPTION OF THE DRAWINGS

In order to provide a clearer explanation of the technical schemes in the prior art or in embodiments of the present application, simple introductions are given below to the drawings that are needed for the embodiments. Obviously, the drawings described below are merely some embodiments of the present application. Persons with ordinary skill in the art could, without expending creative effort, obtain other drawings on the basis of these drawings

FIG. 1 is a diagram of a system for authenticating an identity of a device according to various embodiments of the present disclosure.

FIG. 2 is a flowchart of method for authenticating an identity of a device according to various embodiments of the present disclosure.

FIG. 3 is a flowchart of a method for authenticating an identity of a device according to various embodiments of the present disclosure.

FIG. 4 is a flowchart of a method for authenticating an identity of a device according to various embodiments of the present disclosure.

FIG. 5 is a flowchart of a method for authenticating an identity of a device according to various embodiments of the present disclosure.

FIG. 6 is a flowchart of a method for authenticating an identity of a device according to various embodiments of the present disclosure.

FIG. 7 is a flowchart of a method for authenticating an identity of a device according to various embodiments of the present disclosure.

FIG. 8 is a functional diagram of a computer system for authenticating a device identity according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In order to further clarify the goals, technical schemes, and advantages of the present invention, the present invention is described in detail below in light of the drawings and specific embodiments.

As used herein, a terminal generally refers to a device comprising one or more processors. A terminal can be a device used (e.g., by a user) within a network system and used to communicate with one or more servers. According to various embodiments of the present disclosure, a terminal includes components that support communication functionality. For example, a terminal can be a smart phone, a server, a machine of shared power banks, an information centers (such as one or more services providing information such as traffic or weather, etc.) a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a kiosk such as a vending machine, a smart home appliance, vehicle-mounted mobile stations, or the like. A terminal can run various operating systems.

In some embodiments, a “smart terminal” is a terminal device having multimedia functions. A smart terminal supports audio, video, data, and other such functions. The smart terminal can have a touchscreen. The smart terminal can correspond to a smart mobile device such as a smart phone, a tablet computer, or a smart wearable device, or a smart television, personal computer, or other such device with a touchscreen. Various operating systems such as Android, iOS, YunOS, and tvOS can be implemented on the smart terminal. Various embodiments discussed herein are in the context of the example of a television device using tvOS; however, other types of terminals or operating systems can be used. A smart terminal can be connected to one or more networks such as the Internet, a WiFi network, a Local Area Network (LAN), a Wide Area Network (WAN), a telecommunications network, etc.

As used herein, an authenticatee terminal (or also referred to herein as an authenticate device) and an authenticator equipment (or also referred to herein as an authenticator terminal) can correspond to terminals. As an example, authenticatee terminal can be a terminal such as a smart terminal, a phone, a tablet, etc. As another example, an authenticator equipment can be a terminal such as a server, a router, a network device, etc.

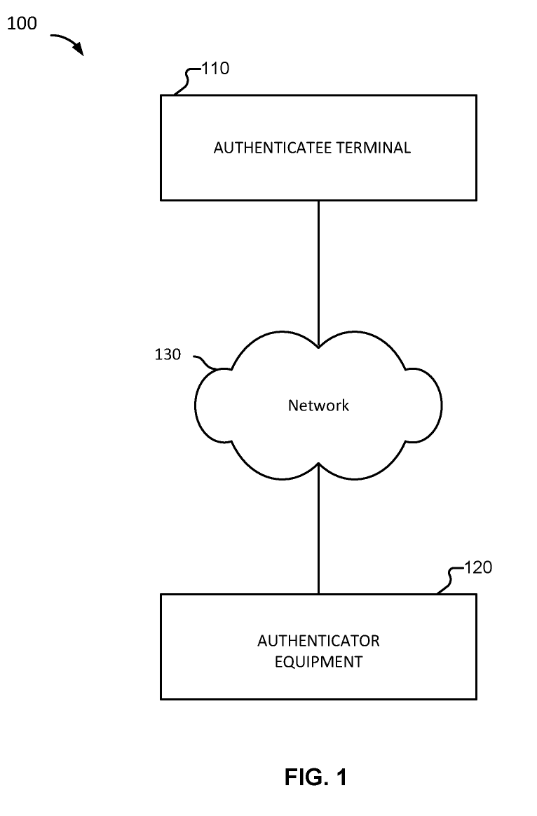

FIG. 1 is a diagram of a system for authenticating an identity of a device according to various embodiments of the present disclosure.

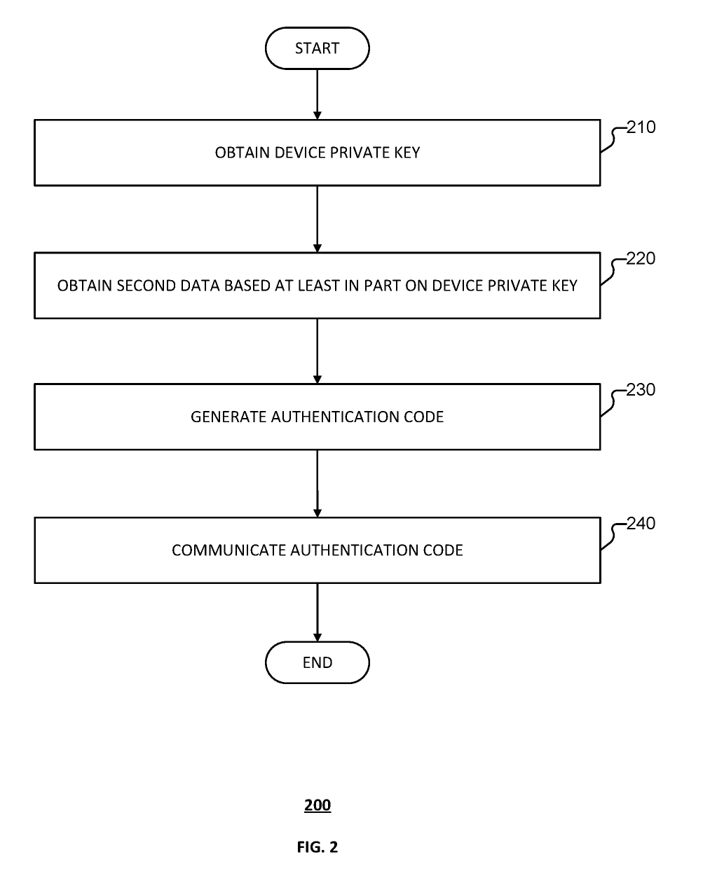

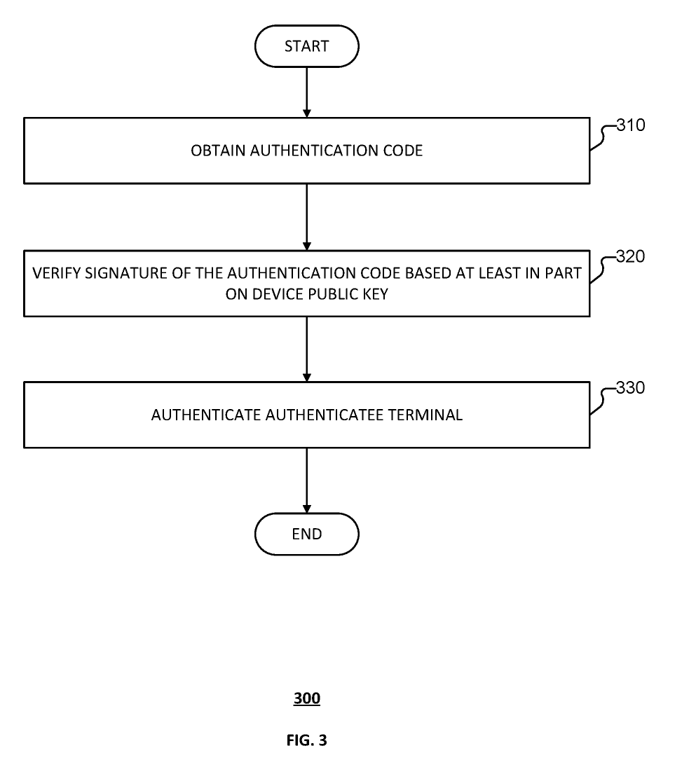

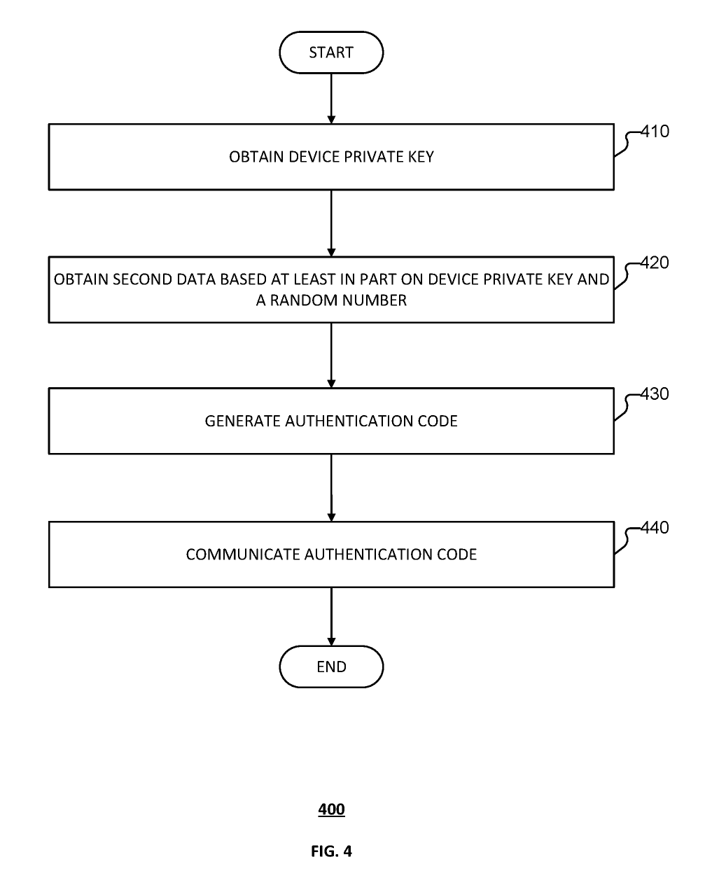

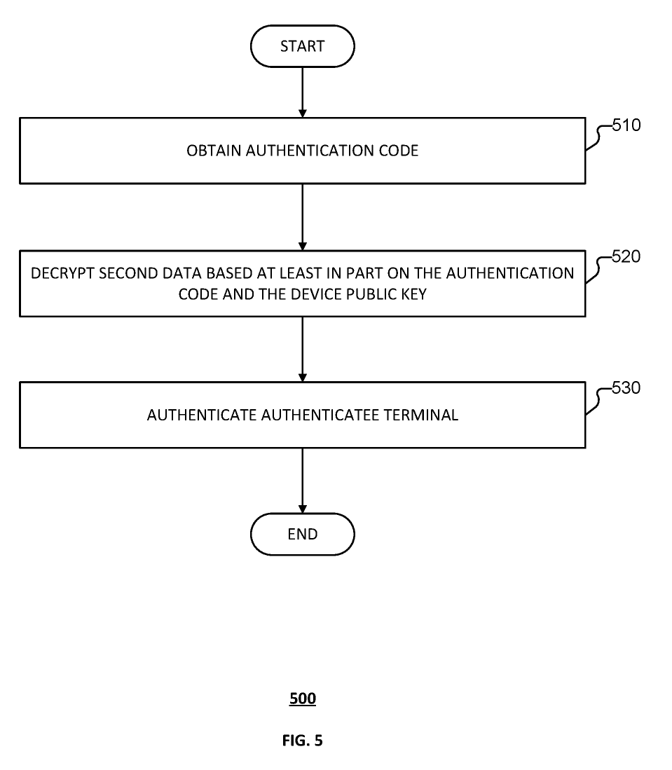

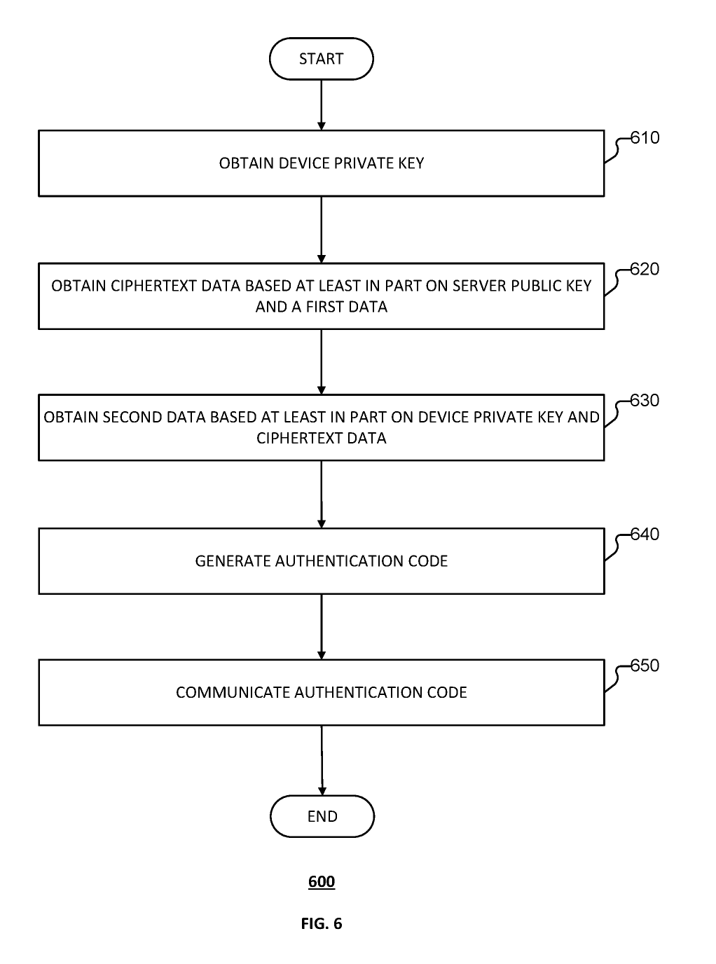

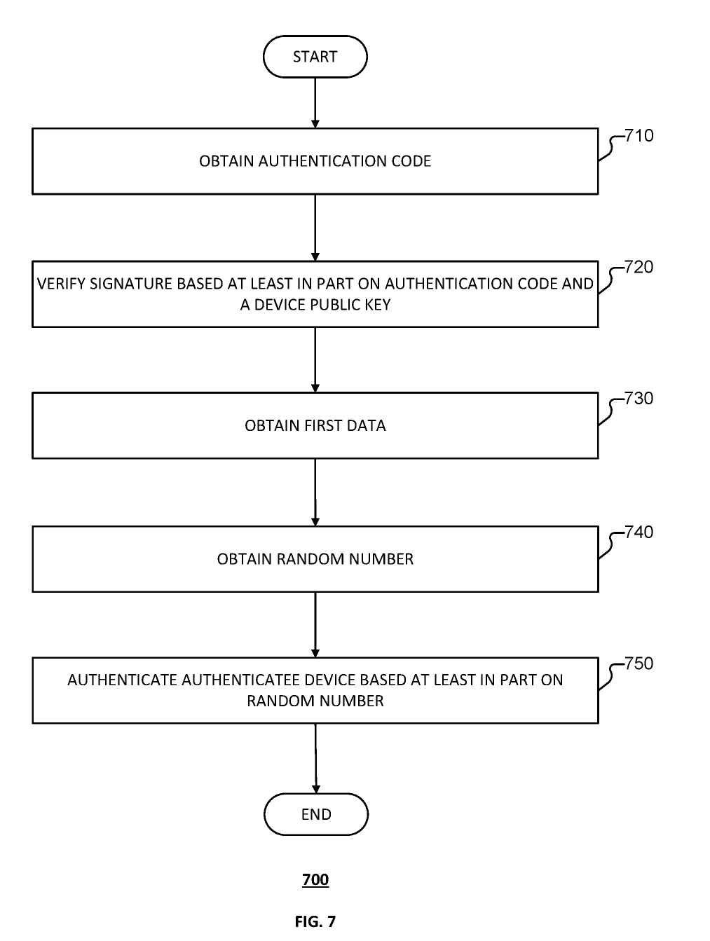

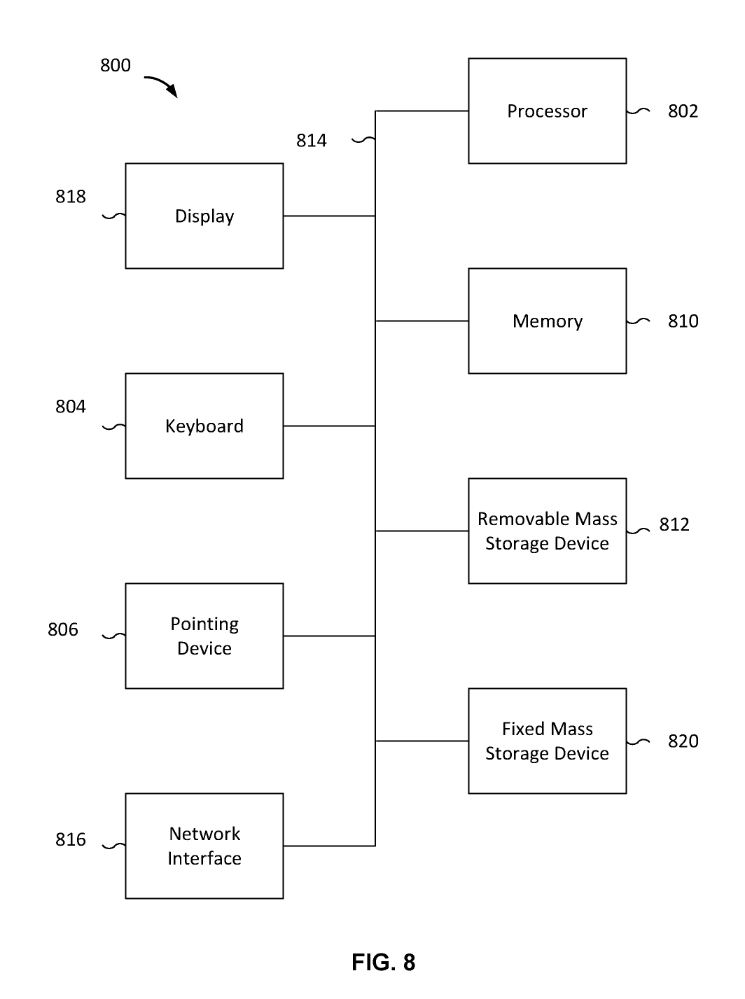

Referring to FIG. 1, system 100 is provided. System 100 can implement at least part of process 200 of FIG. 2, process 300 of FIG. 3, process 400 of FIG. 4, process 500 of FIG. 5, process 600 of FIG. 6, and/or process 700 of FIG. 7. System 100 can implement computer system 800 of FIG. 8.

System 100 comprises an authenticatee terminal 110 and authenticator equipment 120. System 100 can further comprise one or more networks 130 over which authenticatee terminal 110 and authenticator equipment 120 communicate. In some embodiments, system 100 comprises a plurality of authenticatee terminals 110. In some embodiments, authenticator equipment 120 is implemented by one or more servers.

The authenticatee terminal 110 may be any physical devices, including, but not limited to: mobile phones, computers, network devices, smart home devices, wearable devices, and smart medical devices. Computers may include, but are not limited to, PCs, notebook computers, and tablet computers. Network devices may include, but are not limited to, routers, switches, network interface cards, and hubs. Smart home devices may include, but are not limited to, smart televisions, smart air-conditioning, smart humidifiers, smart water heaters, smart kitchen appliances, smart doors and windows, and smart air purifiers. Wearable devices may include, but are not limited to, smart bracelets, smart watches, and smart glasses. Smart medical devices may include, but are not limited to, smart blood pressure gauges, smart bodyweight scales, smart blood sugar meters, and smart massage seats.

Authenticator equipment 120 could be equipment or an equipment cluster at the server end. For example, authenticator equipment 120 could be in the form of a server or a server cluster.

According to various embodiments, authenticator equipment 120 authenticates the authenticatee terminal 110. For example, authenticator equipment 120 performs an authentication process for authenticating authenticatee terminal 110. As an example, authenticatee terminal 110 can be authenticated in connection with the authenticatee terminal 110 attempting to access one or more resources (e.g., a network resource such as a file). As another example, authenticatee terminal 110 can be authenticated in connection with the authenticatee terminal 110 being provided a network service (e.g., a software as a service, etc.). Authenticator equipment 120 receives information from authenticatee terminal 110 in connection with an authentication process, and authenticator equipment 120 can authenticate authenticatee terminal 110 based at least in part on the received information. In some embodiments, the authentication process includes using a public-key cryptography. For example, authenticatee terminal 110 can use a private key to encrypt information, and authenticator equipment 120 can use a corresponding public key in connection with authenticating the information received from authenticatee terminal 110. Authenticator equipment 120 can decrypt the information received from authenticatee terminal 110 based at least in part on the public key corresponding to the private key that was used by authenticatee terminal 110.

According to various embodiments, a device encryption key of an authenticatee terminal is pre-written into authenticatee device 110. If a symmetrical encryption/decryption approach is used in connection with an authentication process, then authenticator equipment 120 stores the same device encryption key. The device encryption key is agreed on in advance by authenticatee device 110 and authenticator equipment 120. Moreover, only authenticator equipment 120 and the authenticatee device 110 know the device encryption key being used to encrypt certain information (e.g., information used in connection with an authentication process). Moreover, terminals such as terminals used by malicious third parties are generally unable to obtain the device encryption key (e.g., by snooping a connection between authenticatee device 110 and authenticator equipment 120, etc.). If an asymmetrical encryption/decryption approach is used in connection with an authentication process, then the device encryption key written into authenticatee terminal 110 can correspond to a device private key, and authenticator equipment 120 stores a device public key corresponding to the device private key of authenticatee terminal 110. The device private key and the device public key constitute an encryption key pair. In some embodiments, the device private key is known only to authenticatee terminal 110 and authenticator equipment 120 and cannot be obtained by other terminals such as terminals used by malicious third parties. According to various embodiments, the device private key is used in connection with generating an authentication code or token that is sent to authenticator equipment 120. Authenticator equipment 120 can uses the authentication code or token to authenticate the identity of authenticatee terminal 110. For example, authenticator equipment 120 decrypts the authentication code or token in connection with authenticating the identity of authenticatee terminal 110.

FIG. 2 is a flowchart of method for authenticating an identity of a device according to various embodiments of the present disclosure.

Referring to FIG. 2, process 200 is provided. Process 200 can be implemented in connection with process 300 of FIG. 3. For example, process 200 can be implemented by authenticatee terminal 110 of system 100 of FIG. 1, and process 300 can be implemented by authenticator equipment 120 of system 100. Process 200 can be implemented in connection with process 400 of FIG. 4 and/or process 600 of FIG. 6. Process 200 can be implemented at least in part by system 100 of FIG. 1, and/or computer system 800 of FIG. 8. In some embodiments, process 200 is implemented in connection with process 500 of FIG. 5, and/or process 700 of FIG. 7.

According to various embodiments, process 200 is implemented by the authenticatee terminal. For example, identity authentication can begin at the authenticatee terminal end. Process 200 can be used as an asymmetrical approach for authentication an identity of the authenticatee terminal (or user thereof).

At 210, a device private key is obtained. The device private key can be pre-stored at the authenticatee terminal. For example, the authenticatee can obtain the device private key from a local storage. In some embodiments, the device private key is provided to the authenticatee terminal in connection a system for which an authentication process is to be performed. For example, the device private key is provided to the authenticatee terminal in connection with a network (e.g., a telecommunications network), a web service, or the like. The device private key can be associated with a corresponding device public key (e.g., to form a public and private key pair).

An authenticatee terminal initiates or performs identity authentication in various contexts, and such contexts are generally according to actual business service needs. For example, if an authenticatee terminal is turned on for the first time, the device activation process generally includes an identity authentication. As another example, if an application in an authenticatee terminal requests a corresponding service, identity authentication may be triggered, and only an authenticatee terminal that has been successfully authenticated can acquire the corresponding service. Various other scenarios in which an authentication process is invoked are possible.

If an authenticatee terminal has been triggered to conduct identity authentication, authenticatee terminal can obtain the pre-stored device private key. For example, in response to the authentication process being invoked, the authenticatee terminal obtains a device private key corresponding to a context for which authentication is being performed. The authenticatee terminal can store various device private keys that are used in various contexts (e.g., authentication for different services, etc.).

In some embodiments, the device private key is stored in secure storage to ensure the security of the device private key. As an example, the secure storage is a secure hardware zone isolated by a mechanism such as ARM TrustZone, Secure Element, or TI M-Shield. As another example, the secure storage is an independent, secure environment isolated using a virtualization mechanism. Secure storage ensures that saved device private keys cannot be falsified or deleted. Regardless of what approach is employed, the objective is to provide a trusted execution environment for obtaining private keys and generating authentication codes. The trusted execution environment ensures the privacy of the device private key.

According to various embodiments, identity authentication is implemented by pre-storing the following information into the authenticatee terminal:

1) Device private key.

2) An identifier (ID) of the authenticatee terminal.

3) Server public key.

The device private key, identifier of the authenticatee terminal, and/or the server public key can be stored in a secure storage of the authenticatee terminal.

The device public key can correspond to the device private key. For example, the device public key and the device private key can be used together in connection with asymmetrical cryptography. The server public key can correspond to a server private key that is used by a server (e.g., the authenticator equipment) to encrypt information provided to the authenticatee terminal. For example, the server public key and a server private key can correspond to a public and private key pair used in connection with an asymmetrical cryptography process.

According to various embodiments, the device private key and the ID of the authenticatee terminal are necessary information for the authenticatee terminal to store or to at least have access for purposes of an authentication process. As an example, the authenticatee terminal is not required to store the server public key for purposes of the authentication process. The device private key is agreed upon in advance by the authenticator equipment and authenticatee terminal and pre-stored at the authenticatee terminal (e.g., in a secure storage of the authenticatee terminal. The authenticator equipment stores (or has access to) the device public key corresponding to the device private key.

The ID of the authenticatee terminal identifies the authenticatee terminal. In some embodiments, the ID of the authenticatee terminal is a unique identifier of the authenticatee terminal. For example, the ID of the authenticatee terminal is the IMEI, a media access control (MAC) address of the authenticatee terminal, etc. In some embodiments, the ID of the authenticatee terminal is based at least in part on the context for which an authentication process is being performed. For example, the ID of the authenticatee terminal can correspond to a user ID or other identifier associated with an account of a web service or application that uses an authentication process. According to various embodiments, the authenticator equipment provides the ID of an authenticatee terminal to the authenticatee terminal. The authenticator equipment can generate the ID of the authenticatee terminal and provide the ID of the authenticatee terminal to the authenticatee terminal. For example, the ID of the authenticatee terminal is provided to an ID-writing device, which writes the ID of the authenticatee terminal into the authenticatee terminal. The authenticatee terminal ID and the server public key may also be stored in secure storage. In some embodiments, the authenticatee terminal is provided with the ID of the authenticatee terminal in connection with a registration process. For example, in response to registering an account, the ID of the authenticatee terminal is provided to the authenticatee terminal.

In some embodiments, the server public key described above also makes use of the example of an asymmetrical encrypting/decrypting approach, according to which the authenticator equipment keeps the corresponding server private key. If a symmetrical approach is employed, then both the authenticator equipment and the authenticatee terminal store the same server encryption key.

As used herein, the “writing” or “storing” includes, but is not limited to, the approach of burning onto device chips, saving to a storage device or module. A device private key-device public key pair may be generated in advance by the authenticator equipment or a corresponding server. As an example, the device private key is provided to the authenticatee terminal during a manufacturing process of the authenticatee terminal or when the authenticatee is shipped from the factory of a manufacturer. As another example, the authenticatee terminal generates a device private key-device public key pair during a manufacturing process of the authenticatee terminal or when the authenticatee terminal is shipped from the factory of a manufacturer. The device public key in the pair is then provided to the authenticator equipment. The server private key and the server private key likewise can be generated by authenticator equipment. As an example, the server public key in the pair is being provided to the authenticatee terminal during a manufacturing process of the authenticatee terminal or when the authenticatee is shipped from the factory of a manufacturer. The authenticatee terminal can generate a server private key-server public key pair during a manufacturing process of the authenticatee terminal or when the authenticatee is shipped from the factory of a manufacturer. The server private key in the pair is then provided to the authenticator equipment.

At 220, second data is obtained based at least in part on the device private key. In some embodiments, first data is signed based on the device private key (e.g., using the device private key), and the resulting signed first data corresponds to the second data. The authenticatee terminal can obtain the second data based at least in part on the device private key. For example, the authenticatee terminal generates the second data using the device private key.

In some embodiments, the first data used in connection with obtaining the second data can be agreed upon by the authenticatee terminal and the terminal equipment (e.g., before the use of the information in the authentication process). The first data can comprise a random number or random value (hereinafter simply referred as a random number). The random number comprised in the first data is agreed to by the authenticatee terminal and the authenticator equipment before the random number is used in the authentication process. For example, if the random number is signed to obtain the second data and the second data is provided to the authenticator equipment for authentication of the authenticatee terminal, then the authenticator equipment decrypts the second data using the corresponding device public key. As a further example, in order to use the resulting decrypted data to authenticate the authenticatee terminal, the authenticator equipment has data to which the decrypted data is to match for the authenticatee terminal to be authenticated.

In connection with generating authentication code, the authenticatee terminal, in addition to obtaining the device private key, determines the random number agreed upon with the authenticator equipment. The random number can be determined according to various processes. Two processes for determining the random number are described below, however, additional processes are possible.

One approach for determining the random number is a real-time request approach. The real-time request approach includes the authenticatee terminal requesting the random number from the authenticator equipment. The authenticator equipment generates one random number for the authenticatee terminal. For example, the authenticator equipment generates the random number in response to receiving the request for the random number from the authenticatee terminal. The authenticator equipment communicates the random number to the authenticatee terminal (e.g., in response to receiving the request for the random number from the authenticatee terminal). To ensure the security of the random number, the authenticator equipment can use the server private key to encrypt the random number, and the authenticatee terminal uses the server public key to decrypt the random number. Conversely, in response to invocation of an authentication process, the authenticatee terminal generates the random number and provides the random number to the authenticator equipment. Similarly, to ensure the security of the random number, the authenticatee terminal can encrypt the random number with the server public key and the authenticator equipment can decrypt the random number using the corresponding server private key. Furthermore, a signature signed with the device private key can be delivered to the authenticator equipment which can subsequently verify the signature by the device public key.

The server public key can be provided by the authenticator equipment to the authenticatee terminal in advance of the authentication process being invoked. For example, the authenticator equipment can pre-generate an encryption key pair (e.g., a server public key-server private key pair), and provide the server public key of the pair to the authenticatee terminal.

Another approach for determining the random number is for both ends of an authentication process to generate the random number. Both ends of the authentication process can simultaneously generate the random number, or both ends can contemporaneously generate the random number (e.g., in connection with an authentication process). For example, the authenticatee terminal and the authenticator equipment each generate the random number. The authenticatee terminal can obtain a random seed agreed upon in advance with the authenticator equipment. The random number can be determined based at least in part on the random seed. The authenticatee terminal and the authenticator terminal can respectively use a predefined random number generator process and the random seed to obtain the random number. On the basis of the random seed, the random number generator process agreed upon in advance with the authenticator equipment is used to generate a random number. Accordingly, the same random seed and the random number generator process can be used at the authenticator equipment end to generate the same random number.

In some embodiments, the random seed corresponds to encryption key information agreed upon in advance by the authenticatee terminal and the authenticator equipment. The random number generator process can correspond to a time-based one-time password (TOTP) technique. The TOTP technique makes use of an initial time stamp TO and interval time TS agreed upon between the authenticator equipment and the authenticatee terminal. The TOTP technique subtracts TO from the current time stamp, divides the resulting time difference by TS and rounds off the quotient to obtain the integer TC. The TOTP technique then performs a hash operation using TC and the agreed upon encryption key information K and thereupon obtains the random number password. A detailed explanation of TOTP will not be provided here. Of course, algorithms or techniques other than the TOTP technique can be employed. According to various embodiments, for authentication processes in which the random number is generated at both ends of the authentication process, the authenticator equipment and authenticatee terminal are able to generate the same random number.

According to various embodiments, in addition to comprising a random number, the first data comprises other data, such as device manufacturer information, ID, other device-related information, etc.

Referring to 210, the first data is signed using the device private key. For example, the first data is hashed using the device private key to obtain signature data. The signature data can undergo signature verification if the device public key corresponding to the device private key is used. Second data is then constituted from the first data and the signature data. The first data can correspond to plaintext data, and the signature data can correspond to ciphertext data.

At 230, an authentication code is generated. The authenticatee terminal can determine the authentication code based at least in part on the second data. The authenticatee terminal determines the authentication code using the second data and an identifier. For example, the authenticatee terminal determines the authentication code using the second data and the ID of the authenticatee terminal. The authentication code can be generated based on the second data that is obtained from signing the random number using the device private key. The authentication code can be generated (e.g., determined) according to a predefined protocol or process.

At 240, the authentication code is communicated. In some embodiments, the authenticatee terminal communicates the authentication code to the authenticator equipment. The authenticatee terminal can communicate the authentication to the authenticator equipment over one or more networks. In some embodiments, the authentication code is communicated in connection with an access request (e.g., to a network or to a service), or an authentication process. As an example, the authenticatee terminal can provide the authentication code in a request for access (e.g., to a network or a service such as a web service).

In some embodiments, the authenticator equipment uses the authentication code in connection with authenticating the authenticatee terminal. For example, the authenticator equipment determines that the authenticatee terminal is valid (e.g., information obtained from the authentication code matches information locally stored at the authenticator equipment, or otherwise stored on the authenticator equipment end). In response to authenticating the authenticatee terminal (e.g., determining that the authenticatee terminal is valid), the authenticator equipment can provide (or permit access to) one or more services to the authenticatee terminal.

FIG. 3 is a flowchart of a method for authenticating an identity of a device according to various embodiments of the present disclosure.

Referring to FIG. 3, process 300 is provided. Process 300 can be implemented in connection with process 200 of FIG. 2. For example, process 200 can be implemented by authenticatee terminal 110 of system 100 of FIG. 1, and process 300 can be implemented by authenticator equipment 120 of system 100. Process 300 can be implemented in connection with process 500 of FIG. 5 and/or process 700 of FIG. 7. Process 300 can be implemented at least in part by system 100 of FIG. 1, and/or computer system 800 of FIG. 8. In some embodiments, process 300 is implemented in connection with process 400 of FIG. 4, and/or process 600 of FIG. 6.

At 310, an authentication code is obtained. In some embodiments, the authenticator equipment obtains the authentication code from the authenticatee terminal. The authenticatee terminal can communicate the authentication to the authenticator equipment over one or more networks. In some embodiments, the authentication code is communicated in connection with an access request (e.g., to a network or to a service), or an authentication process. As an example, the authenticatee terminal can provide the authentication code in a request for access (e.g., to a network or a service such as a web service).

The authenticator equipment can process the authentication code to obtain information. For example, the authenticator equipment obtains second data from the authentication code. The authenticator code can also obtain an identifier that was used in generating the authentication code. For example, if the authentication code was generated using the second data and the ID of the authenticatee terminal, the authenticator equipment can obtain the second data and the ID of the authenticatee terminal from the authentication code.

At 320, a signature of the authentication code is verified based at least part on the device public key. The authenticator equipment can verify a signature of the authentication code by using a public key corresponding to the private key that was used by the authenticatee terminal to sign or encrypt the authentication code or information comprised therein. In some embodiments, the authenticator equipment uses the second data and the device public key in connection with signature verification. For example, the authenticator equipment obtains the second data from the authenticator code and uses the second data and the device public key in connection with signature verification. The authenticator equipment decrypts the second data using the device public key.

The authenticator equipment can obtain the device public key corresponding to the authenticator code based at least in part on the authenticator code. For example, the authenticator equipment can obtain an identifier (e.g., the ID of the authenticatee terminal) from the authentication code and use the identifier to obtain the corresponding device public key. The authenticator equipment can look up the corresponding device public key in a mapping of identifiers to device public keys. For example, the authenticator equipment uses the identifier obtained from the authentication code to look up and obtain the corresponding device public key from the mapping of identifiers to device public keys. The authenticator equipment stores mappings between identifiers (e.g., pre-stored IDs of authenticatee terminals) and device public keys. The mappings can be used to determine the device public key corresponding to the ID of the authenticatee terminal.

If signature verification is conducted using a device public key, the device public key can be used to sign the first data contained in the second data. As an example, the second data can be decrypted using the device public key and the first data can be obtained according to the decrypted second data. The obtained signature data (e.g., the first data can be obtained according to the decrypted second data) is compared with the signature data contained in the second data. For example, plaintext data is extracted from the second data. After the plaintext data is signed with the device public key, ciphertext signature data is obtained, and a comparison is made between self-obtained signature data and the signature data comprised in the second data. If the plaintext data and the self-obtained signature data are consistent, then the signature verification is confirmed as successful, and a random number is acquired from the first data. Otherwise, the signature verification is confirmed a failure, and a message of signature verification failure can be returned.

At 330, the authenticatee terminal is authenticated. The authenticatee terminal can be authenticated based at least in part on a random number obtained based at least in part on the authentication code. For example, the random number obtained with the signature verification is used to authenticate the authenticatee terminal.

In connection with authenticating the authenticatee terminal, the authenticator equipment determines the random number agreed upon with the authenticatee terminal. The random number can be determined according to various processes. Two processes for determining the random number are described below, however, additional processes are possible.

One approach for determining the random number is for the authenticator equipment to generate the random number. For example, the authenticator equipment generates the random number in response to receiving a request for a random number from the authenticatee terminal. After the authenticator equipment receives a request for the random number from the authenticatee terminal, the authenticator equipment generates the random number communicates the random number to the authenticatee terminal. The authenticator equipment can ensure the security of the random number by encrypting the random number with a server private key and then communicating the encrypted random number back to the authenticatee terminal. Thus, the authenticatee terminal uses the server public key to decrypt the random number.

Another approach for determining the random number is for both ends of an authentication process to generate the random number. Both ends of the authentication process can simultaneously generate the random number, or both ends can contemporaneously generate the random number (e.g., in connection with an authentication process). The authenticator equipment obtains a random seed agreed upon in advance with the authenticatee terminal. The random number can be determined based at least in part on the random seed. The authenticatee terminal and the authenticator terminal can respectively use a predefined random number generator process and the random seed to obtain the random number. On the basis of the random seed, the random number generator process agreed upon in advance with the authenticatee terminal is used to generate the random number. The random seed may include encryption key information agreed upon in advance by the authenticator equipment and the authenticatee terminal. The random number generator process used to generate the random number may be a technique such as TOTP.

The authenticator equipment and the authenticatee terminal can agree in advance on which approach for generating the random number to employ and thus ensure that the random numbers determined at the two ends will be the same.

The authenticating of the authenticatee terminal comprises comparing the random number determined by the authenticator equipment to the random number obtained from the first data (e.g., that is obtained from the authentication code). If the random number determined by the authenticator equipment and the random number obtained from the first data are consistent, then the verification identity of the authenticatee terminal is confirmed successful. If the random number determined by the authenticator equipment and the random number obtained from the first data are not consistent, then the verification identity of the authenticatee terminal is confirmed successful. The authentication result may thereupon be communicated to the authenticatee terminal.

In some embodiments, the authenticator equipment uses the authentication code in connection with authenticating the authenticatee terminal. For example, the authenticator equipment determines that the authenticatee terminal is valid (e.g., information obtained from the authentication code matches information locally stored at the authenticator equipment, or otherwise stored on the authenticator equipment end). In response to authenticating the authenticatee terminal (e.g., determining that the authenticatee terminal is valid), the authenticator equipment can provide (or permit access to) one or more services to the authenticatee terminal.

FIG. 4 is a flowchart of a method for authenticating an identity of a device according to various embodiments of the present disclosure.

Referring to FIG. 4, process 400 is provided. Process 400 can be implemented in connection with process 500 of FIG. 5. For example, process 400 can be implemented by authenticatee terminal 110 of system 100 of FIG. 1, and process 500 can be implemented by authenticator equipment 120 of system 100. Process 400 can be implemented in connection with process 200 of FIG. 2 and/or process 600 of FIG. 6. Process 400 can be implemented at least in part by system 100 of FIG. 1, and/or computer system 800 of FIG. 8. In some embodiments, process 400 is implemented in connection with process 300 of FIG. 3, and/or process 700 of FIG. 7.

According to various embodiments, process 400 is implemented by the authenticatee terminal. For example, identity authentication can begin at the authenticatee terminal end. Process 400 can be used as an asymmetrical approach for authentication an identity of the authenticatee terminal (or user thereof).

At 410, a device private key is obtained. The device private key can be pre-stored at the authenticatee terminal. For example, the authenticatee can obtain the device private key from a local storage. In some embodiments, the device private key is provided to the authenticatee terminal in connection a system for which an authentication process is to be performed. For example, the device private key is provided to the authenticatee terminal in connection with a network (e.g., a telecommunications network), a web service, or the like. The device private key can be associated with a corresponding device public key (e.g., to form a public and private key pair).

In some embodiments, the device private key of process 400 corresponds to the device private key described in connection with process 200 of FIG. 2.

At 420, second data is obtained based at least in part on the device private key. In some embodiments, first data is signed or encrypted based on the device private key (e.g., using the device private key), and the resulting signed or encrypted first data corresponds to the second data. The authenticatee terminal can obtain the second data based at least in part on the device private key. For example, the authenticatee terminal generates the second data using the device private key.

In some embodiments, the first data used in connection with obtaining the second data can be agreed upon by the authenticatee terminal and the terminal equipment (e.g., before the use of the information in the authentication process). The first data can comprise a random number. The random number comprised in the first data is agreed to by the authenticatee terminal and the authenticator equipment before the random number is used in the authentication process. For example, if the random number is signed or encrypted to obtain the second data and the second data is provided to the authenticator equipment for authentication of the authenticatee terminal, then the authenticator equipment decrypts the second data using the corresponding device public key. As a further example, in order to use the resulting decrypted data to authenticate the authenticatee terminal, the authenticator equipment has data to which the decrypted data is to match for the authenticatee terminal to be authenticated.

The random number used in connection with process 400 can be determined in the manner by which the random number of process 200 is determined.

420 differs from 220 in that 420 uses a device private key to encrypt the first data comprise the random number so as to obtain ciphertext data. The ciphertext corresponds to the second data.

At 430, an authentication code is generated. The authenticatee terminal can determine the authentication code based at least in part on the second data. The authenticatee terminal determines the authentication code using the second data and an identifier. For example, the authenticatee terminal determines the authentication code using the second data and the ID of the authenticatee terminal. The authentication code can be generated based on the second data that is obtained from signing the random number using the device private key. The authentication code can be generated (e.g., determined) according to a predefined protocol or process.

At 440, the authentication code is communicated. In some embodiments, the authenticatee terminal communicates the authentication code to the authenticator equipment. The authenticatee terminal can communicate the authentication to the authenticator equipment over one or more networks. In some embodiments, the authentication code is communicated in connection with an access request (e.g., to a network or to a service), or an authentication process. As an example, the authenticatee terminal can provide the authentication code in a request for access (e.g., to a network or a service such as a web service).

In some embodiments, the authenticator equipment uses the authentication code in connection with authenticating the authenticatee terminal. For example, the authenticator equipment determines that the authenticatee terminal is valid (e.g., information obtained from the authentication code matches information locally stored at the authenticator equipment, or otherwise stored on the authenticator equipment end). In response to authenticating the authenticatee terminal (e.g., determining that the authenticatee terminal is valid), the authenticator equipment can provide (or permit access to) one or more services to the authenticatee terminal.

FIG. 5 is a flowchart of a method for authenticating an identity of a device according to various embodiments of the present disclosure.

Referring to FIG. 5, process 500 is provided. Process 500 can be implemented in connection with process 400 of FIG. 4. For example, process 400 can be implemented by authenticatee terminal 110 of system 100 of FIG. 1, and process 500 can be implemented by authenticator equipment 120 of system 100. Process 500 can be implemented in connection with process 300 of FIG. 3 and/or process 700 of FIG. 7. Process 500 can be implemented at least in part by system 100 of FIG. 1, and/or computer system 800 of FIG. 8. In some embodiments, process 500 is implemented in connection with process 200 of FIG. 2, and/or process 600 of FIG. 6.

At 510, an authentication code is obtained. In some embodiments, the authenticator equipment obtains the authentication code from the authenticatee terminal. The authenticatee terminal can communicate the authentication to the authenticator equipment over one or more networks. In some embodiments, the authentication code is communicated in connection with an access request (e.g., to a network or to a service), or an authentication process. As an example, the authenticatee terminal can provide the authentication code in a request for access (e.g., to a network or a service such as a web service).

The authenticator equipment can process the authentication code to obtain information. For example, the authenticator equipment obtains second data from the authentication code. The authenticator code can also obtain an identifier that was used in generating the authentication code. For example, if the authentication code was generated using the second data and the ID of the authenticatee terminal, the authenticator equipment can obtain the second data and the ID of the authenticatee terminal from the authentication code.

At 520, second data is decrypted based at least part on the device public key and the authentication code. The authenticator equipment can obtain second data from the authentication code and decrypt the second data using a public key corresponding to the private key that was used by the authenticatee terminal to sign or encrypt the authentication code or information comprised therein. In some embodiments, the authenticator equipment uses the second data and the device public key in connection with signature verification. For example, the authenticator equipment obtains the second data from the authenticator code and uses the second data and the device public key in connection with signature verification. The authenticator equipment decrypts the second data using the device public key.

The authenticator equipment can obtain the device public key corresponding to the authenticator code based at least in part on the authenticator code. For example, the authenticator equipment can obtain an identifier (e.g., the ID of the authenticatee terminal) from the authentication code and use the identifier to obtain the corresponding device public key. The authenticator equipment can look up the corresponding device public key in a mapping of identifiers to device public keys. For example, the authenticator equipment uses the identifier obtained from the authentication code to look up and obtain the corresponding device public key from the mapping of identifiers to device public keys. The authenticator equipment stores mappings between identifiers (e.g., pre-stored IDs of authenticatee terminals) and device public keys. The mappings can be used to determine the device public key corresponding to the ID of the authenticatee terminal.

The authenticator equipment obtains plaintext first data based on decrypting the second data corresponding to the authentication code. Further, the authenticator equipment obtains the random number that was used to generate first data based on the plaintext first data.

520 of process 500 can differ from 320 of process 300 of FIG. 3 in that the authenticator equipment uses a device public key corresponding to the ID of the authenticatee terminal to decrypt the second data, obtain plaintext first data, and obtain the random number from the first data.

At 530, the authenticatee terminal is authenticated. The authenticatee terminal can be authenticated based at least in part on a random number obtained based at least in part on the authentication code. For example, the random number obtained with the signature verification is used to authenticate the authenticatee terminal.

The random number used in connection with process 500 can be determined in the manner by which the random number of process 200 is determined.

The authenticating of the authenticatee terminal comprises comparing the random number determined by the authenticator equipment to the random number obtained from the first data (e.g., that is obtained from the authentication code). If the random number determined by the authenticator equipment and the random number obtained from the first data are consistent, then the verification identity of the authenticatee terminal is confirmed successful. If the random number determined by the authenticator equipment and the random number obtained from the first data are not consistent, then the verification identity of the authenticatee terminal is confirmed successful. The authentication result may thereupon be communicated to the authenticatee terminal.

In some embodiments, the authenticator equipment uses the authentication code in connection with authenticating the authenticatee terminal. For example, the authenticator equipment determines that the authenticatee terminal is valid (e.g., information obtained from the authentication code matches information locally stored at the authenticator equipment, or otherwise stored on the authenticator equipment end). In response to authenticating the authenticatee terminal (e.g., determining that the authenticatee terminal is valid), the authenticator equipment can provide (or permit access to) one or more services to the authenticatee terminal.

FIG. 6 is a flowchart of a method for authenticating an identity of a device according to various embodiments of the present disclosure.

Referring to FIG. 6, process 600 is provided. Process 600 can be implemented in connection with process 700 of FIG. 7. For example, process 600 can be implemented by authenticatee terminal 110 of system 100 of FIG. 1, and process 700 can be implemented by authenticator equipment 120 of system 100. Process 600 can be implemented in connection with process 200 of FIG. 2 and/or process 400 of FIG. 4. Process 600 can be implemented at least in part by system 100 of FIG. 1, and/or computer system 800 of FIG. 8. In some embodiments, process 600 is implemented in connection with process 300 of FIG. 3, and/or process 500 of FIG. 5.

At 610, a device private key is obtained. The device private key can be pre-stored at the authenticatee terminal. For example, the authenticatee can obtain the device private key from a local storage. In some embodiments, the device private key is provided to the authenticatee terminal in connection a system for which an authentication process is to be performed. For example, the device private key is provided to the authenticatee terminal in connection with a network (e.g., a telecommunications network), a web service, or the like. The device private key can be associated with a corresponding device public key (e.g., to form a public and private key pair).

In some embodiments, the device private key of process 600 corresponds to the device private key described in connection with process 200 of FIG. 2.

At 620, ciphertext is obtained based at least in part on a server public key and first data. In some embodiments, first data is signed or encrypted based on the server public key (e.g., using the server public key), and the resulting signed or encrypted first data corresponds to the ciphertext. The authenticatee terminal can obtain the ciphertext based at least in part on the server public key. For example, the authenticatee terminal generates the ciphertext using the server public key.

In some embodiments, the first data used in connection with obtaining the ciphertext data can be agreed upon by the authenticatee terminal and the terminal equipment (e.g., before the use of the information in the authentication process). The first data can comprise a random number. The random number comprised in the first data is agreed to by the authenticatee terminal and the authenticator equipment before the random number is used in the authentication process. For example, if the random number is signed or encrypted to obtain the ciphertext and the ciphertext (or information based on the ciphertext) is provided to the authenticator equipment for authentication of the authenticatee terminal, then the authenticator equipment decrypts the ciphertext using the corresponding server private key. As a further example, in order to use the resulting decrypted data to authenticate the authenticatee terminal, the authenticator equipment has data to which the decrypted data is to match for the authenticatee terminal to be authenticated.

The random number used in connection with process 600 can be determined in the manner by which the random number of process 200 is determined.

At 630, second data is obtained based at least in part on the device private key. In some embodiments, the ciphertext is signed or encrypted based on the device private key (e.g., using the device private key), and the resulting signed or encrypted first data corresponds to the second data. The authenticatee terminal can obtain the second data based at least in part on the device private key. For example, the authenticatee terminal generates the second data using the device private key.

In some embodiments, the ciphertext used in connection with obtaining the second data is determined based at least in part on the server public key and the first data.

In some embodiments, the authenticatee terminal first encrypts the first data comprising the random number (e.g., using the server public key) and then signs the obtained ciphertext data. The obtained second data includes ciphertext data and signature data obtained from signing the ciphertext data. The signature data is determined (e.g., generated) in connection with signing the ciphertext with the device private key.

In addition, process 600 can further include first signing the first data with a device private key, thus obtaining signature data, and then encrypting the first data and the signature data to obtain second data.

At 640, an authentication code is generated. The authenticatee terminal can determine the authentication code based at least in part on the second data. The authenticatee terminal determines the authentication code using the second data and an identifier. For example, the authenticatee terminal determines the authentication code using the second data and the ID of the authenticatee terminal. The authentication code can be generated based on the second data that is obtained from signing the random number using the device private key. The authentication code can be generated (e.g., determined) according to a predefined protocol or process.

At 650, the authentication code is communicated. In some embodiments, the authenticatee terminal communicates the authentication code to the authenticator equipment. The authenticatee terminal can communicate the authentication to the authenticator equipment over one or more networks. In some embodiments, the authentication code is communicated in connection with an access request (e.g., to a network or to a service), or an authentication process. As an example, the authenticatee terminal can provide the authentication code in a request for access (e.g., to a network or a service such as a web service).

In some embodiments, the authenticator equipment uses the authentication code in connection with authenticating the authenticatee terminal. For example, the authenticator equipment determines that the authenticatee terminal is valid (e.g., information obtained from the authentication code matches information locally stored at the authenticator equipment, or otherwise stored on the authenticator equipment end). In response to authenticating the authenticatee terminal (e.g., determining that the authenticatee terminal is valid), the authenticator equipment can provide (or permit access to) one or more services to the authenticatee terminal.

FIG. 7 is a flowchart of a method for authenticating an identity of a device according to various embodiments of the present disclosure.

Referring to FIG. 7, process 700 is provided. Process 700 can be implemented in connection with process 600 of FIG. 6. For example, process 600 can be implemented by authenticatee terminal 110 of system 100 of FIG. 1, and process 700 can be implemented by authenticator equipment 120 of system 100. Process 700 can be implemented in connection with process 300 of FIG. 3 and/or process 500 of FIG. 5. Process 700 can be implemented at least in part by system 100 of FIG. 1, and/or computer system 800 of FIG. 8. In some embodiments, process 700 is implemented in connection with process 200 of FIG. 2, and/or process 400 of FIG. 4.

At 710, an authentication code is obtained. In some embodiments, the authenticator equipment obtains the authentication code from the authenticatee terminal. The authenticatee terminal can communicate the authentication to the authenticator equipment over one or more networks. In some embodiments, the authentication code is communicated in connection with an access request (e.g., to a network or to a service), or an authentication process. As an example, the authenticatee terminal can provide the authentication code in a request for access (e.g., to a network or a service such as a web service).

The authenticator equipment can process the authentication code to obtain information. For example, the authenticator equipment obtains second data from the authentication code. The authenticator code can also obtain an identifier that was used in generating the authentication code. For example, if the authentication code was generated using the second data and the ID of the authenticatee terminal, the authenticator equipment can obtain the second data and the ID of the authenticatee terminal from the authentication code.

At 720, a signature of the authentication code is verified based at least part on the device public key. The authenticator equipment can verify a signature of the authentication code by using a public key corresponding to the private key that was used by the authenticatee terminal to sign or encrypt the authentication code or information comprised therein. In some embodiments, the authenticator equipment uses the second data and the device public key in connection with signature verification. For example, the authenticator equipment obtains the second data from the authenticator code and uses the second data and the device public key in connection with signature verification. The authenticator equipment decrypts or signs the second data using the device public key.

Second data is obtained from the authentication code. For example, the authenticator equipment extracts the second data from the authentication code. Because the second data contains ciphertext data and signature data corresponding to this ciphertext data, the authenticator equipment can use a device public key (e.g., corresponding to the device private key) to sign the ciphertext data and compare the obtained signature data to the signature data comprised in the second data. If the signature data comprised in the second data is consistent with (e.g., matches) the obtained signature data (e.g., that is obtained by the authenticator equipment using the device public key), then the signature verification is successful, and process proceeds to 730. If the signature data comprised in the second data is not consistent with (e.g., does not match) the obtained signature data (e.g., that is obtained by the authenticator equipment using the device public key), then the signature verification fails, and a message of signature verification failure may be returned, ending process 700.

At 730, first data is obtained. The authenticator equipment can obtain the first data based at least in part on the ciphertext comprised in the second data. For example, the authenticator equipment can use the server private key in connection with obtaining the first data. The authenticator equipment uses the server private key to decrypt the ciphertext data contained in the second data so as to obtain the first data.

If the authenticatee terminal employs the approach wherein authenticatee terminal first obtains signature data by signing the first data with the device private key and then obtains second data by encrypting the first data and the signature with the server public key, the authenticator equipment accordingly will first use the server private key to decrypt the second data and obtain the first data and the signature data. Then authenticatee terminal signs the first data with the device public key to obtain signature data and compares the obtained signature data to the decrypted signature data. If the signature data comprised in the second data is consistent with (e.g., matches) the obtained signature data, then the verification is successful. Otherwise, the verification fails. In some embodiments, if the verification is successful, process 700 proceeds to 740 at which the random number is acquired from the first data.

At 740, the random number is obtained. The authenticator equipment obtains the random number from the first data. In some embodiments, 730 and 740 are combined (e.g., if the first data corresponds to the random number).

At 330, the authenticatee terminal is authenticated. The authenticatee terminal can be authenticated based at least in part on a random number obtained based at least in part on the authentication code. For example, the random number obtained with the signature verification is used to authenticate the authenticatee terminal.

FIG. 8 is a functional diagram of a computer system for authenticating a device identity according to various embodiments of the present disclosure.

Referring to FIG. 8, computer system 800 is provided. Computer system 800 can implement at least part of process 200 of FIG. 2, process 300 of FIG. 3, process 400 of FIG. 4, process 500 of FIG. 5, process 600 of FIG. 6, and/or process 700 of FIG. 7. Computer system 800 can be implemented by system 100 of FIG. 1.

Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818).

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data, and objects used by the processor 802 to perform its functions (e.g., programmed instructions). For example, memory 810 can include any suitable computer-readable storage media, described below, depending on whether, for example, data access needs to be bi-directional or uni-directional. For example, processor 802 can also directly and very rapidly retrieve and store frequently needed data in a cache memory (not shown). The memory can be a non-transitory computer-readable storage medium.

A removable mass storage device 812 provides additional data storage capacity for the computer system 800, and is coupled either bi-directionally (read/write) or uni-directionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storage device 812 and fixed mass storage 820 generally store additional programming instructions, data, and the like that typically are not in active use by the processor 802. It will be appreciated that the information retained within mass storage device 812 and fixed mass storage 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

It should be understood that the devices and methods that are disclosed in the several embodiments provided above can be realized in other ways. For example, the device embodiment described above is merely illustrative. For example, the delineation of units is merely a delineation according to local function. The delineation can take a different form during actual implementation.

The above-described identity authentication method, device, computer system, and system provided by various embodiments of the present invention can be applied to multiple identity authentication scenarios, including, but not limited to the following scenarios.

Device identity authentication in network business services. For example, if a device is to request a business service in a network, the device can include in the request the authentication code described in various embodiments. The corresponding business service is permitted to be released to the authenticatee terminal only after the authenticator equipment at the server end has conducted successful authentication using this authentication code.

Identity authentication of devices in the process of measuring device flow volumes. In the process of measuring flow volumes of devices, there are often devices that falsify or forge their identities in order to evade flow volume measurement. Thus, an authentication code is included during the process of measuring flow volumes. The authentication code is used to test the true identities of the devices.

Please understand that in the several embodiments provided by the present invention the disclosed system, device, and method may be realized in other ways. For example, the device embodiment described above is merely illustrative. For example, the delineation of units is merely a delineation according to local function. The delineation can take a different form during actual implementation.

Units described as separate components may or may not be physically separate, and components displayed as units may or may not be physical units. They can be located in one place, or they can be distributed across multiple network units. The embodiment schemes of the present embodiments can be realized by selecting part or all of the units in accordance with actual need.

Furthermore, the functional units in the various embodiments of the present invention can be integrated into one processing unit, or each unit can have an independent physical existence, or two or more units can be integrated into a single unit. The aforesaid integrated units can take the form of hardware, or they can take the form of hardware combined with software function units.

The units described above, in which the software function units are integrated, can be stored in a computer-readable storage medium. The software function units described above are stored in a storage medium and include a number of instructions whose purpose is to cause a piece of computer equipment (which can be a personal computer, a server, or network computer) or a processor to execute some of the steps in the method described in the various embodiments of the present invention. The storage medium described above encompasses: USB flash drive, mobile hard drive, read-only memory (ROM), random access memory (RAM), magnetic disk, or optical disk, or various other media that can store program code.

The preferred embodiments of the present invention that are described above are merely that and do not limit the present invention. Any modification, equivalent substitution, or improvement that is made in keeping with the spirit and principles of the present invention shall be included within the protective scope of the present invention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining, by one or more processors associated with an authenticatee terminal, a device encryption key;
obtaining, by one or more processors associated with the authenticatee terminal, second data, wherein the second data is obtained based at least in part on the device encryption key and first data, and the obtaining the second data comprises at least one of signing or encrypting the first data, and the first data comprises a random number;
generating, by one or more processors associated with the authenticatee terminal, an authentication code based at least in part on the second data and an identifier (ID) of the authenticatee terminal; and
communicating, by one or more processors associated with the authenticatee terminal, the authentication code to an authenticator equipment.

2. The method of claim 1, wherein the device encryption key was pre-written to the authenticatee terminal.

3. The method of claim 1, wherein:
the random number is stored by both the authenticatee terminal and the authenticator equipment before the random number is comprised in the first data, or
the random number is separately determined both the authenticatee terminal and the authenticator equipment according to a predetermined random number generating process.

4. The method of claim 1, wherein obtaining the device encryption key comprises:
obtaining the device encryption key from a local secure storage of the authenticatee terminal; or
obtaining the device encryption key and the ID of the authenticatee terminal from the local secure storage of the authenticatee terminal.

5. The method of claim 1, further comprising:
determining, by the one or more processors associated with an authenticatee terminal, the random number.

6. The method of claim 5, wherein the determining the random number comprises:
requesting, by one or more processors associated with an authenticatee terminal, the random number from the authenticator equipment;
obtaining the random number communicated by the authenticator equipment.

7. The method of claim 6, wherein the obtaining the random number communicated by the authenticator equipment comprises:
obtaining an encrypted random number from the authenticator equipment; and
decrypting the encrypted random number based at least in part on a server encryption key, wherein the server encryption key is stored by both an authenticator equipment and the authenticatee terminal.

8. The method of claim 7, wherein the server encryption key is stored by both an authenticator equipment and the authenticatee terminal.

9. The method of claim 7, wherein the server encryption key stored at the authenticatee terminal is a server public key, and the server encryption key stored at the authenticator equipment is a server private key corresponding to the server public key.

10. The method of claim 5, wherein the determining the random number comprises:
obtaining a random seed, wherein the authenticator equipment and the authenticatee terminal separately store the random seed before the random number is determined;
generating the random number based at least in part on the random seed and a predefined random number generating process.

11. The method of claim 10, wherein the random seed comprises encryption key information wherein the authenticator equipment and the authenticatee terminal separately store at least part of the encryption key information before the random number is determined; and
the predefined random number generating process comprises: a time-based one-time password (TOTP) process.

12. The method of claim 1, wherein the obtaining the second data based at least in part on the device encryption key and first data comprises:
signing first data based at least in part on the device encryption key to obtain the second data; or
encrypting at least the first data based at least in part on the device encryption key to obtain the second data; or
encrypting at least the first data based at least in part on a server encryption key to obtain ciphertext data, signing the ciphertext data based at least in part on the device encryption key to obtain the second data; or
signing the first data based at least in part on the device encryption key to obtain signature data, and encrypting at least the signature data based at least in part on the server encryption key to obtain the second data.

13. The method of claim 1, wherein the ID of the authenticatee terminal is generated by the authenticator equipment and provided to the authenticatee terminal before an authentication process is invoked.

14. The method of claim 1, wherein the obtaining the device encryption key obtaining the second data, and generating an authentication code are executed in a trusted execution environment of the authenticatee terminal.

15. The method of claim 1, wherein the device encryption key stored at the authenticatee is a device private key, and the device encryption key stored at the authenticator equipment corresponds to a device public key corresponding to the device private key.

16. The method of claim 1, wherein a version of the device encryption key is stored by both an authenticator equipment and the authenticatee terminal.

17. The method of claim 1, wherein the random number is an alphanumeric string.

18. The method of claim 1, further comprising:
in response to the authenticate terminal being authenticated, obtaining one or more network resources, or
in response to the authenticate terminal being authenticated, receiving a service from one or more servers.

19. The method of claim 1, wherein the authentication code is communicated to the authenticator equipment for the authenticator equipment to perform authentication of the authenticatee terminal using the authentication code.

20. A method, comprising:
obtaining, by one or more processors associated with an authenticator equipment, an authentication code that is communicated by an authenticatee terminal, wherein the authentication code comprises second data, and an identifier (ID) of the authenticatee terminal;
obtaining, by one or more processors associated with the authenticator equipment, a device encryption key corresponding to the ID of the authenticatee terminal;
obtaining, by one or more processors associated with the authenticator equipment, a random number based at least in part on a signature verification of the second data using the device encryption key or a decryption of at least the second data using the device encryption key; and
authenticating, by one or more processors associated with the authenticator equipment, the authenticatee terminal based at least in part on the random number.

21. The method of claim 20, further comprising:
in response to authenticating the authenticatee terminal, providing one or more services to the authenticatee terminal.

22. The method of claim 20, further comprising:
obtaining an identifier (ID) of the authenticatee terminal based at least in part on the authentication code; and
determining a device encryption key corresponding to the ID of the authenticatee terminal based at least in part on a mapping of pre-stored IDs to authenticatee terminals.

23. The method of claim 20, wherein the obtaining the random number based at least in part on the signature verification of the second data using the device encryption key or the decryption of at least the second data using the device encryption key comprises:
signing first data comprised in the second data based at least in part on the device encryption key, comparing obtained signature data to signature data comprised in second data, determining that signature verification is successful based on whether the obtained signature and the signature data comprised in the second data are consistent, and obtaining the random number from the first data in response to determining the signature verification is successful; and determining that the signature verification failed in response to determining that the obtained signature and the signature data comprised in the second data are not consistent; or
decrypting second data based at least in part on the device encryption key to obtain the first data, and obtaining the random number from the first data; or
signing ciphertext data comprised in the second data based at least in part on the device encryption key, comparing obtained signature data to the signature data comprised in the second data, determining that the signature verification is successful based on whether the obtained signature and the signature data comprised in the second data are consistent, and decrypting the random number from the ciphertext data based at least in part on a server encryption key in response to determining that the obtained signature and the signature data comprised in the second data are consistent, and determining that the signature verification failed if the obtained signature and the signature data comprised in the second data are not consistent; or
obtaining signature data and first data based at least in part on decrypting the second data using the server encryption key, signing the first data based at least in part on the device encryption key, comparing the obtained signature data to the decrypted signature data, determining that the signature verification is successful based on whether the obtained signature data to the decrypted signature data are consistent, and obtaining the random number from the first data if the obtained signature data to the decrypted signature data are consistent, and determining that the signature verification failed the obtained signature data to the decrypted signature data are not consistent.

24. The method of claim 23, wherein the server encryption key is a server private key corresponding to the server public key and the authenticatee terminal stores a server public key corresponding to the server private key.

25. The method of claim 20, wherein authenticating the authenticatee terminal based at least in part on the random number comprises:
determining whether a pre-stored random number and the random number obtained using the decryption key are consistent;
in response to determining that the pre-stored random number and the random number obtained using the decryption key are consistent, determining that authentication of the authenticatee terminal is successful; and
in response to determining that the pre-stored random number and the random number obtained using the decryption key are not consistent, determining that the authentication of the authenticatee terminal failed.

26. The method of claim 25, further comprising:
determining the pre-stored random number.

27. The method of claim 26, determining the pre-stored random number comprises:
receiving a request for the random number from the authenticatee terminal; and
in response to receiving the request for the random number, providing the random number to the authenticatee terminal, wherein the random number communicated to the authenticatee terminal matches the pre-stored random number.

28. The method of claim 27, wherein the providing the random number to the authenticatee terminal comprises:
encrypting the random number based at least in part on a server encryption key; and
communicating an encrypted random number to the authenticatee terminal, wherein the authenticator equipment stores a first version of the server encryption key, and the authenticatee terminal stores a second version server encryption key.

29. The method of claim 25, wherein the determining the pre-stored random number comprises:
obtaining a random seed, wherein the authenticator equipment and the authenticatee terminal separately store the random seed before the random number is determined;
generating the random number based at least in part on the random seed and a predefined random number generating process.

30. The means of claim 25, wherein the random seed comprises: encryption key information, wherein the authenticator equipment and the authenticatee terminal separately store at least part of the encryption key information before the random number is determined;
the predefined random number generating process comprises: a time-based one-time password (TOTP) algorithm.

31. The method of claim 20, further comprising:
generating the ID of the authenticatee terminal; and
providing the ID of the authenticatee terminal to the authenticatee terminal.

32. The method of claim 20, wherein the device encryption key is a device public key, and a device private key of the device encryption key corresponding to a device public key of the device encryption key is pre-written into the authenticatee terminal.

33. The method of claim 20, wherein the random number is an alphanumeric string.

34. A terminal, comprising:
one or more processors configured to:
obtain a device encryption key, wherein the device encryption key is stored by both an authenticator equipment and the authenticatee terminal;
obtain second data, wherein the second data is obtained based at least in part on the device encryption key and first data, and the obtaining the second data comprises at least one of signing or encrypting the first data, and the first data comprises a random number;
generate an authentication code based at least in part on the second data and an identifier (ID) of the authenticatee terminal; and
communicate the authentication code to an authenticator equipment; and
one or more memories coupled to the one or more processors, configured to provide the one or more processors with instructions.

35. A terminal, comprising:
one or more processors configured to:
obtain an authentication code that is communicated by an authenticatee terminal, wherein the authentication code comprises second data, and an identifier (ID) of the authenticatee terminal;
obtain a device encryption key corresponding to the ID of the authenticatee terminal;
obtain a random number based at least in part on a signature verification of the second data using the device encryption key or a decryption of at least the second data using the device encryption key; and
authenticate the authenticatee terminal based at least in part on the random number; and
one or more memories coupled to the one or more processors, configured to provide the one or more processors with instructions.

36. A computer program product, the computer program product being embodied in a non-transitory computer readable storage medium and comprising computer instructions for:
obtaining a device encryption key, wherein the device encryption key is stored by both an authenticator equipment and the authenticatee terminal;
obtaining second data, wherein the second data is obtained based at least in part on the device encryption key and first data, and the obtaining the second data comprises at least one of signing or encrypting the first data, and the first data comprises a random number;
generating an authentication code based at least in part on the second data and an identifier (ID) of the authenticatee terminal; and
communicating the authentication code to an authenticator equipment.

37. A computer program product, the computer program product being embodied in a non-transitory computer readable storage medium and comprising computer instructions for:
obtaining an authentication code that is communicated by an authenticatee terminal, wherein the authentication code comprises second data, and an identifier (ID) of the authenticatee terminal;
obtaining a device encryption key corresponding to the ID of the authenticatee terminal;
obtaining a random number based at least in part on a signature verification of the second data using the device encryption key or a decryption of at least the second data using the device encryption key; and
authenticating the authenticatee terminal based at least in part on the random number.

38. A device identity authentication system, comprising;
an authenticatee terminal, comprising:
one or more processors associated with the authenticatee terminal, the one or more processors configured to:
obtain a first device encryption key, wherein the first device encryption key is stored by both an authenticator equipment and the authenticatee terminal;
obtain second data, wherein the second data is obtained based at least in part on the first device encryption key and first data, and the obtaining the second data comprises at least one of signing or encrypting the first data, and the first data comprises a random number;
generate an authentication code based at least in part on the second data and an identifier (ID) of the authenticatee terminal; and
communicate the authentication code to an authenticator equipment; and
one or more memories associated with the authenticatee terminal and coupled to the one or more processors associated with the authenticatee terminal, the one or more memories associated with the authenticatee terminal configured to provide the one or more processors associated with the authenticatee terminal with instructions; and
an authenticator equipment, comprising:
one or more processors associated with the authenticator equipment, the one or more processors associated with the authenticator equipment configured to:
obtain the authentication code that is communicated by to authenticatee terminal, wherein the authentication code comprises second data, and an identifier (ID) of the authenticatee terminal;
obtain a second device encryption key corresponding to the ID of the authenticatee terminal;
obtain a random number based at least in part on a signature verification of the second data using the second device encryption key or a decryption of at least the second data using the second device encryption key; and
authenticate the authenticatee terminal based at least in part on the random number; and
one or more memories associated with the authenticator equipment and coupled to the one or more processors associated with the authenticator equipment, the one or more memories associated with the authenticator equipment configured to provide the one or more processors associated with the authenticator equipment with instructions.
